(19) United States
(12) Patent Application Publication
(10) Pub. No.: US 2023/0003994 A1
(43) Pub. Date: Jan. 5, 2023

(54) WAVELENGTH CONVERSION ELEMENT, WAVELENGTH CONVERSION DEVICE, AND LIGHT-EMISSION SYSTEM

(71) Applicant: SHARP KABUSHIKI KAISHA, Sakai City, Osaka (JP)

(72) Inventors: TORU KANNO, Sakai City, Osaka (JP); SHIGERU AOMORI, Sakai City, Osaka (JP); HIDEOMI YUI, Sakai City, Osaka (JP); TOMOKO UEKI, Sakai City, Osaka (JP)

(21) Appl. No.: 17/782,087

(22) PCT Filed: Oct. 6, 2020
(86) PCT No.: PCT/JP2020/037834

§ 371 Date: Jun. 2, 2022

(30) Foreign Application Priority Data
Dec. 4, 2019 (JP) 2019-219630

(51) Int. Cl. G02B 26/00; F21S 41/176; F21S 41/32; G03B 21/20

(52) U.S. Cl. CPC G02B 26/008; F21S 41/176; F21S 41/321; G03B 21/204

(57) ABSTRACT

A wavelength conversion element is provided that has excellent thermal conductance and high luminous efficiency. The wavelength conversion element includes: a binder; a plurality of phosphor particles dispersed in the binder, the plurality of phosphor particles being configured to emit light with a prescribed wavelength under excitation light; and a plurality of voids dispersed in the binder, at least some of the plurality of voids including, on at least a part of an inner wall thereof, a first coating film formed from metal alkoxide.

### TECHNICAL FIELD

The present disclosure relates to wavelength conversion elements, wavelength conversion devices, and light-emission systems. The present disclosure hereby claims priority to Japanese Patent Application, Tokugan, No. 2019-219630 filed Dec. 4, 2019, the entire contents of which are incorporated herein by reference.

### BACKGROUND ART

There is known a conventional technique where a blue laser bean or other excitation light is shone onto a wavelength conversion element containing phosphor particles dispersed in a binder, so that the wavelength conversion element emits fluorescent light which is extracted for application purposes.

As an example, Patent Literature 1 describes a wavelength conversion element including an antireflective section containing phosphor particles dispersed in a translucent medium. The phosphor particles have an irregular, fine structure thereon.

Patent Literature 2 describes a phosphor layer composition containing: a binder composed of a translucent gel of either a metal alkoxide or a mixture of a metal alkoxide and a metal oxide; and phosphor particles dispersed in the binder.

### CITATION LIST

### Patent Literature

Patent Literature 1: Japanese Unexamined Patent Application Publication, Tokukai, No. 2011-89117

Patent Literature 2: PCT International Application Publication No. WO2019/004064

### SUMMARY OF INVENTION

### Technical Problem

FIG. 2 is a schematic cross-sectional view of a wavelength conversion element of related art including a fluorescent film of phosphor particles 2 dispersed in a binder 1. FIG. 9 is an SEM image of a cross-section of the wavelength conversion element of related art. The wavelength conversion element of related art is typically manufactured by firing or otherwise drying a composition containing the binder I and the phosphor particles 2.

Referring to FIGS. 2 and 9, the wavelength conversion element of related art cracks when fired in the manufacture, so that the finished wavelength conversion element includes therein a plurality of voids 4 as well as the binder I and the phosphor particles 2. These voids 4 block internal thermal conduction X of the wavelength conversion element, thereby reducing the thermal conductivity of the wavelength conversion element. Therefore, the wavelength conversion element of related art, which may contain phosphor particles that can emit high-luminance light under excitation light, will likely heat up to high temperature where the phosphor particles exhibit decreased luminous efficiency, hence failing to achieve desirable fluorescence intensity.

Meanwhile, the wavelength conversion element described in Patent Literature 1 is an attempt to improve the incidence efficiency of excitation light into phosphor particles and the extraction efficiency of produced fluorescence, by providing an irregular, fine structure on the phosphor particles. This wavelength conversion element however has internal voids. In addition, bubbles may form when gaps in the nano-sized fine structure on the phosphor particles are filled with a translucent medium such as silicone resin or glass. The presence of these voids and bubbles will likely reduce the thermal conductivity and the luminous efficiency of the phosphor particles.

The phosphor layer composition described in Patent Literature 2 is an attempt to improve the absorption of excitation light by the phosphor particles and the extraction efficiency of produced fluorescence, by restraining reflection at the interface between the phosphor particles and the binder. Patent Literature 2 is silent about the voids that can form in, for example, firing, hence falling short of addressing the problem of decreased thermal conductivity in the presence of such voids.

The present disclosure has been made in view of these problems and has an object to provide a wavelength conversion element that has excellent thermal conductance and high luminous efficiency.

### Solution to Problem

To address the problems, the present disclosure, in one aspect thereof, is directed to a wavelength conversion element including: a binder, a plurality of phosphor particles dispersed in the binder, the plurality of phosphor particles being configured to emit light with a prescribed wavelength under excitation light; and a plurality of voids dispersed in the binder, at least some of the plurality of voids including, on at least a part of an inner wall thereof, a first coating film formed from metal alkoxide.

### Advantageous Effects of Invention

The present disclosure, in one aspect thereof, provides a wavelength conversion element that has excellent thermal conductance and high luminous efficiency.

### BRIEF DESCRIPTION OF DRAWINGS

FIG. 1 is a schematic cross-sectional view of a wavelength conversion element in accordance with Embodiments 1 and 2 of the present disclosure.

FIG. 2 is a schematic cross-sectional view of a wavelength conversion element of related art.

FIG. 3 is a schematic cross-sectional view of a wavelength conversion element in accordance with Embodiment 3 of the present disclosure.

FIG. 4 is a schematic cross-sectional view of a wavelength conversion element in accordance with Embodiment 4 of the present disclosure.

FIG. 5 is a schematic cross-sectional view of a wavelength conversion device in accordance with Embodiment 5 of the present disclosure.

FIG. 6 is a schematic cross-sectional view of a wavelength conversion device in accordance with Embodiment 6 of the present disclosure.

FIG. 7 is an SEM image of a cross-section of the wavelength conversion element in accordance with Embodiment 1 of the present disclosure.

FIG: 8 is an SEM image of a cross-section of the wavelength conversion element in accordance with Embodiment 2 of the present disclosure.

FIG. 9 is an SEM image of a cross-section of the wavelength conversion element of related art.

FIG. 10 is an SEM image of the surface of the wavelength conversion element in accordance with Embodiment 3 of the present disclosure.

FIG. 11 is an SEM image of the surface of the wavelength conversion element in accordance with Embodiment 3 of the present disclosure.

FIG. 12 is an SEM image of the surface of a wavelength conversion element of related art.

FIG. 13 is an SEM image of the surface of a wavelength conversion element of related art.

FIG. 14 is an SEM image of the surface of the wavelength conversion element in accordance with Embodiment 4 of the present disclosure.

FIG. 15 is a graph representing a relationship between energy density and fluorescence luminance.

FIG. 16 is a graph representing a relationship between peak laser power density and peak temperature.

FIG. 17 is a schematic view of a structure of a light-emission system in accordance with Embodiment 7 of the present disclosure.

FIG. 18 is a schematic view of a structure of a light-emission system in accordance with Embodiment 8 of the present disclosure.

FIG. 19 is a plan view of a structure of a light-emission system in accordance with Embodiment 9 of the present disclosure.

FIG. 20 is a side view of the structure of the light-emission system in accordance with Embodiment 9 of the present disclosure.

FIG. 21 is a schematic view of a structure of a light-emission system in accordance with Embodiment 10 of the present disclosure.

FIG. 22 is a schematic view of a structure of a light-emission system in accordance with Embodiment 11 of the present disclosure.

### DESCRIPTION OF EMBODIMENTS

### Embodiment 1

The following will describe an embodiment of the present disclosure in detail.

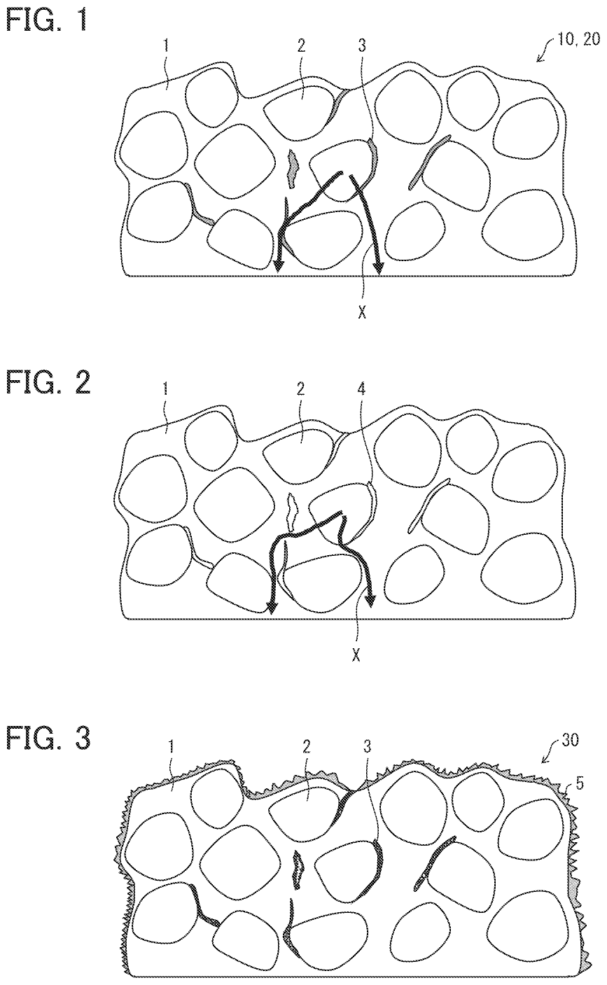

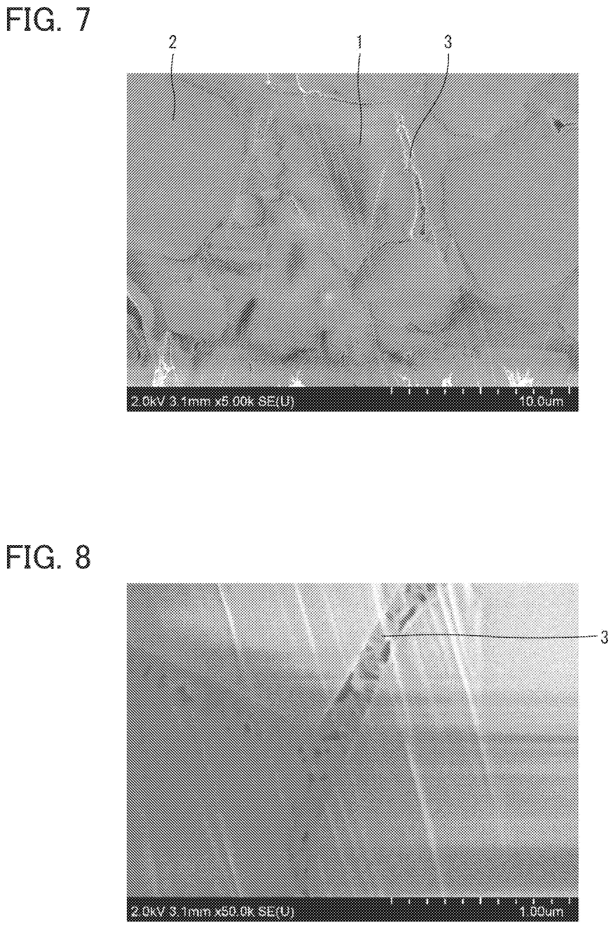

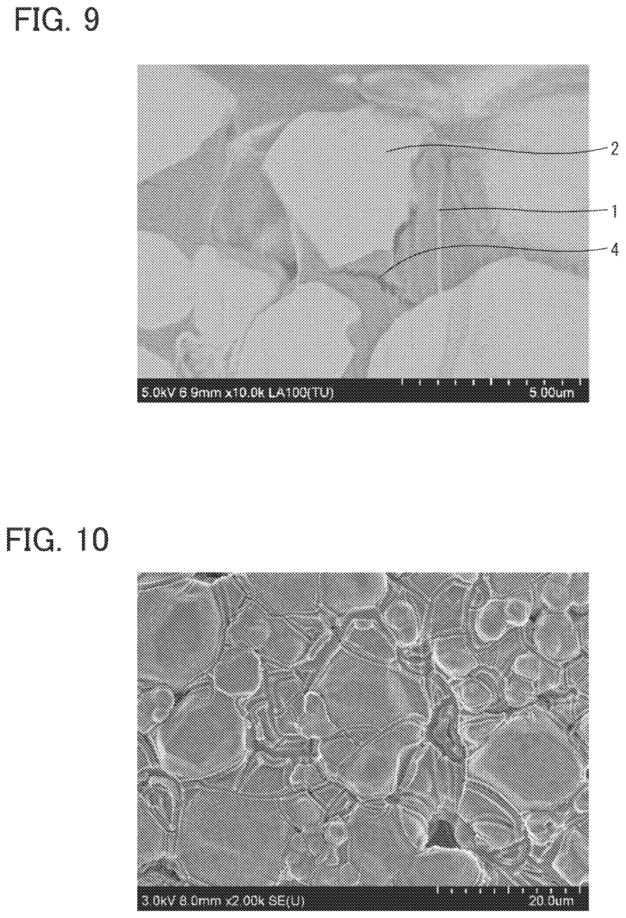

FIG. 1 is a schematic cross-sectional view of a wavelength conversion element 10 in accordance with the present embodiment. FIG. 7 is an SEM image (magnification ratio: 5,000) of a cross-section of the wavelength conversion element 10 in accordance with the present embodiment, prepared by slicing using a cross-section polisher. FIGS. 1 and 7 show that the wavelength conversion element 10 contains: a binder 1; a plurality of phosphor particles 2, dispersed in the binder 1, that emit light with a prescribed wavelength under excitation light; and a plurality of voids dispersed in the binder 1. At least some of the voids have a first coating film 3 of metal alkoxide on at least a part of the inner wall thereof.

The voids with the first coating film 3, unlike the related-art voids 4 with no coating film, provide a thermal conduction path and do not block internal thermal conduction X of the wavelength conversion element. This structure therefore increases the thermal conductivity of the wavelength conversion element. When the phosphor particles emit high-luminance light under excitation light, the accompanying heat is promptly discharged out of the wavelength conversion element. The structure hence increases luminous efficiency, thereby achieving high fluorescence intensity.

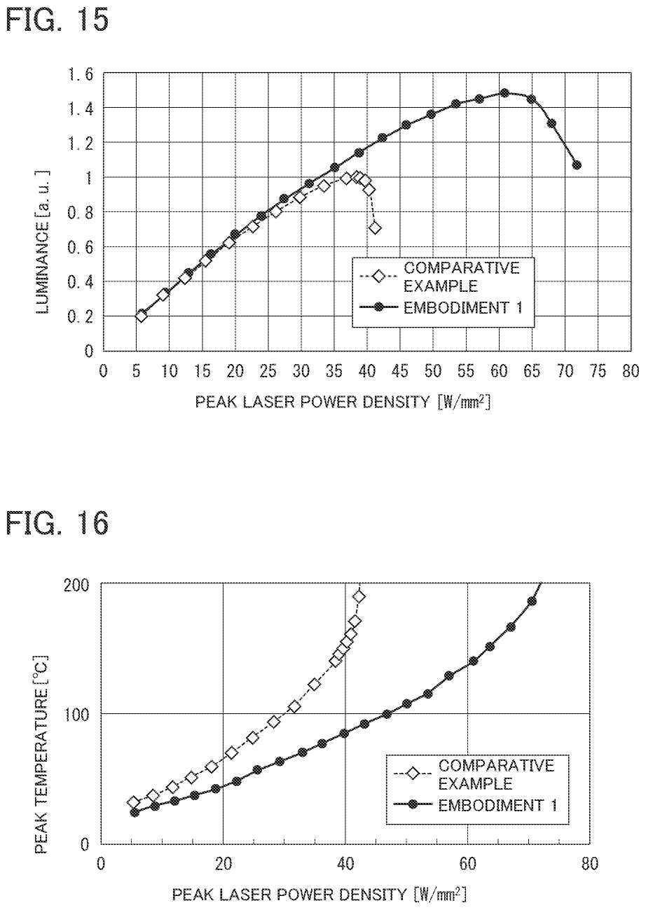

FIG. 15 is a graph representing a relationship between energy density and fluorescence luminance for the wavelength conversion element 10 (Embodiment 1) in accordance with the present embodiment and a wavelength conversion element (comparative example) of related art. FIG. 15 shows that the wavelength conversion element 10 in accordance with the present embodiment, including the first coating film 3 in the voids, can withstand a high level of laser power (irradiation energy density) in excess of 60 W/mm² and achieve a high level of fluorescence luminance in excess of 1.4 a.u. In contrast, the wavelength conversion element of related art, similarly structured except for the absence of coating film, exhibits decreased luminous efficiency and hence decreased fluorescence luminance under laser power of 40 W/mm².

FIG. 16 is a graph representing a relationship between peak laser power density and peak temperature for the wavelength conversion element 10 (Embodiment 1) in accordance with the present embodiment and a wavelength conversion element (comparative example) of related art. FIG. 16 shows that the wavelength conversion element 10 in accordance with the present embodiment has lower surface temperature, higher thermal conductance, and higher heat dissipation than the wavelength conversion element of related art under the same laser power (irradiation energy density).

### Binder 1

Although not limited in any particular manner, the binder 1 preferably contains an inorganic compound for enhanced heat resistance. Examples of such an inorganic compound include alumina, silica, and zinc oxide. Alumina and zinc oxide are particularly preferred in view of their thermal conductance.

The binder 1 may contain inorganic nanoparticles with an average primary particle diameter of approximately 1 to 1,000 nm in a preferred embodiment. Examples of such inorganic nanoparticles include those of a metal or a metal compound. Particularly preferred among these examples are nanoparticles of a metal oxide such as silica or alumina.

The inorganic nanoparticles are not limited in any particular manner in shape and may be spherical, spheroidal, fibrous, bulky, or acicular, When the inorganic nanoparticles are spherical, the “particle diameter” is equivalent to the diameter of the sphere; when the inorganic nanoparticles are not spherical, the “particle diameter” is equivalent to the diameter of the circumscribed sphere of the inorganic nanoparticle. In the specification of the present application, the average primary particle diameter of the inorganic nanoparticles is the arithmetic average of the particle diameters of 10 to 100 particles, obtained by observation of the inorganic nanoparticles under an electron microscope.

### Phosphor Particles 2

The phosphor particles 2 are not limited in any particular manner and may be publicly known phosphor particles. Preferably, the phosphor particles 2 are garnet-based inorganic phosphor particles prepared using alumina as the base material, in view of material cost, manufacturing cost, and optical properties. Examples of such garnet-based inorganic phosphor particles include YAG:Ce (yellow phosphor) and LuAG:Ce (green phosphor). Garnet-based inorganic phosphor particles emit high-luminance light under high-intensity excitation light. It is known however that these phosphor particles have a decreased luminous efficiency at high temperature. In contrast, the wavelength conversion element in accordance with the present disclosure can prevent the phosphor particles from being overheated and suffering from falling luminous efficiency owing to its high thermal conductivity.

### First Coating Film 3

The first coating film 3 inside the voids is a translucent film-like member prepared from a metal alkoxide by a publicly known sol-gel technique. The metal alkoxide may be a mixture with a metal oxide. Examples of the metal in the metal alkoxide and the metal oxide include silicon, aluminum, tin, zinc, zirconium, and titanium. Preferred among these examples are aluminum alkoxide prepared using alumina as the base material and a mixture of aluminum alkoxide and alumina, similarly to the garnet-based inorganic phosphor particles above.

The first coating film 3, if provided inside at least some of the voids dispersed in the binder 1, can increase the thermal conductance and luminous efficiency of the wavelength conversion element. The proportion of the total volume of those voids with the first coating film 3 to the total volume of the voids dispersed in the binder 1 is not limited in any particular manner. A higher proportion will be more effective in improving on the thermal conductance and luminous efficiency.

The first coating film 3 needs only to be in contact with at least a part of the inner wall of the void to provide a thermal conduction path.

### Method of Manufacturing Wavelength Conversion Element 10

Next will be described a method of manufacturing the wavelength conversion element 10 in accordance with the present embodiment by way of an example.

The wavelength conversion element 10 in accordance with the present embodiment can be suitably manufactured by a method involving: a mixing step of mixing a binder solution as the binder I and the phosphor particles 2 to prepare a phosphor ink composition; a film-forming step of forming a film-like member of this phosphor ink composition; a firing step of firing this film-like member to obtain a fired product with voids; a permeation step of permeating this fired product with a sol prepared from a metal alkoxide; and a removal step of removing the medium from the fired product permeated with the sol.

When the binder 1 is a binder containing inorganic nanoparticles, the binder solution is preferably a sol of inorganic nanoparticles that may contain: inorganic nanoparticles; a medium; and where necessary, a stabilizer that maintains the dispersion of the inorganic nanoparticles. The medium is not limited in any particular manner and may be, for example, water, an alcohol-based medium, or a mixture of these substances. Examples of the alcohol-based medium include ethanol and isopropyl alcohol.

The mix ratio of the binder solution and the phosphor particles 2 in the mixing step where a phosphor ink composition is prepared is not limited in any particular manner and may be specified as appropriate in accordance with, for example, a desirable level of fluorescence intensity.

The film-like member may be prepared from a phosphor ink composition by a publicly known film-forming technique in the film-forming step where a film-like member of a phosphor ink composition is formed. For instance, a phosphor ink composition may be applied, for example, onto a substrate by a conventional technique such as spray coating, inkjet coating, dispenser coating, screen printing, or dipping, to form a film-like member. The thickness of the film-like member is not limited in any particular manner and may be suitably specified in accordance with the desirable thickness to the wavelength conversion element.

In the firing step of obtaining a fired product with voids, the medium is removed from the binder solution to obtain a fired product containing the phosphor particles 2 dispersed in the binder 1. Cracks form in firing, which creates the voids in the fired product. The firing temperature and firing time may be suitably specified in accordance with, for example, the binder to be used and may be, for example, 200 to 400° C. and 60 minutes.

The metal alkoxide sol used in the permeation step where the fired product is permeated with a metal alkoxide sol may be suitably prepared by hydrolysis of a metal alkoxide by a publicly known sol-gel technique. As an example of such a sol preparation technique, the following will describe an example of a method of preparing an alumina sol from aluminum alkoxide.

First, isopropyl alcohol (WA) is added to aluminum tri-sec-butoxide (Al(O-sec-Bu)₃), and the resultant mixture is stirred for approximately 1 hour at room temperature. Ethyl acetoacetate (EAcAc) is also added as a chelating agent, and the resultant mixture is stirred for approximately 3 hours at room temperature. Next, water (H₂O) and WA are carefully added dropwise, which completes the preparation of an alumina sol. The ratio of these ingredients may be adjusted in a suitable manner and may be, as an example, Al(O-sec-Bu)₃:IPA:EAcAc:H2O=1:20:1:4.

The fired product obtained in the firing step is permeated with the metal alkoxide sol, so that the sol can go into and fill the voids in the fired product. The permeation technique is not limited in any particular manner and may be a conventional coating technique such as spray coating, inkjet coating, dispenser coating, screen printing, or dipping.

The medium in the sol is removed by drying or firing in the removal step where the medium is removed from the fired product permeated with the sol, so that the sol can gelate and form the first coating film 3 on the inner wall of at least some of the voids. The process temperature and process time for the drying and firing may be suitably specified in accordance with, for example, the type and quantity of the medium used.

### Embodiment 2

The following will describe another embodiment of the present disclosure. For convenience of description, members of the present embodiment that have the same function as members described in the previous embodiment are indicated by the same reference numerals, and description thereof is not repeated.

### Structure of Wavelength Conversion Element 20

FIG. 1 is a schematic cross-sectional view of a wavelength conversion element 20 in accordance with the present embodiment. FIG. 8 is an SEM image (magnification ratio: 50,000) of a cross-section of the wavelength conversion element 20 in accordance with the present embodiment, prepared by slicing using a cross-section polisher. Referring to FIG. 8, the wavelength conversion element 20 in accordance with the present embodiment differs from the wavelength conversion element 10 in accordance with Embodiment 1 in that in the former, the first coating film 3 in the voids has thereon an irregular, fine structure with bumps having a height of approximately from a few tens of nanometers to a few hundred nanometers. The wavelength conversion element 20 has otherwise the same structure as in Embodiment 1.

The irregular structure on the first coating film 3 reduces the difference in refractive index between the air in the void and the first coating film 3, which restrains reflection at the interface between the air and the first coating film 3. That in turn enhances the extraction efficiency for the fluorescent light generated by the wavelength conversion element 20. In the specification of the present application, the “fluorescence extraction efficiency” refers to the “intensity of output fluorescence of wavelength conversion element” divided by the “intensity of excitation light.” The irregular structure is more preferably a flower-like structure. A “flower-like structure” is an irregular structure with individual bumps being randomly directed and shaped like a fine plate of approximately a few tens of nanometers to a few hundred nanometers in thickness, approximately a few tens of nanometers to a few hundred nanometers in height, and approximately a few nanometers to a few tens of nanometers in length. The individual platelike bumps preferably have an aspect ratio (height-to-length ratio) larger than 1. A larger aspect ratio will be more effective in reducing surface reflection.

### Method of Manufacturing Wavelength Conversion Element 20

The wavelength conversion element 20 in accordance with the present embodiment can be suitably manufactured by a method involving: an immersion step of immersing the wavelength conversion element 10 in accordance with Embodiment 1 in boiled water (boiling); and a post-boiling, second firing step.

The immersion step boils the wavelength conversion element 10 for 10 to 30 minutes in warm water at approximately 60 to 100° C. This boiling hydrates the first coating film 3 in the voids, thereby forming the irregular, fine structure on the first coating film 3.

Next, in the second firing step, the post-boiling wavelength conversion element 10 is fired at 100 to 200° C. for 60 minutes to dry the wavelength conversion element 10.

In a preferred embodiment, if the first coating film 3 is a gelled product of an alumina sol prepared from aluminum alkoxide, the immersion step forms flower-like alumina of an alumina hydrate (boehmite: Al₂O₃.H₂O) on the first coating film 3. Next, the second firing step is performed to dry the wavelength conversion element 10. The dried wavelength conversion element 10 may, where necessary, be fired further at 400 to 500° C. to turn boehmite to gamma alumina, thereby forming flower-like alumina of alumina (oxide). It is known that flower-like alumina is composed of alumina or alumina hydrate and forms a flower-like structure thereon.

### Embodiment 3

The following will describe another embodiment of the present disclosure. For convenience of description, members of the present embodiment that have the same function as members described in the previous embodiments are indicated by the same reference numerals, and description thereof is not repeated.

### Structure of Wavelength Conversion Element 30

FIG. 3 is a schematic cross-sectional view of a wavelength conversion element 30 in accordance with the present embodiment.

Referring to FIG. 3, the wavelength conversion element 30 in accordance with the present embodiment differs from Embodiments 1 and 2 in that in the former, the wavelength conversion element has thereon a second coating film 5 of a metal alkoxide that has an irregular, fine structure with bumps having a height of approximately from a few tens of nanometers to a few hundred nanometers. The wavelength conversion element 30 has otherwise the same structure as in Embodiments 1 and 2.

The second coating film 5 is a translucent film-like member prepared from a metal alkoxide by a publicly known sol-gel technique, similarly to the first coating film 3 formed in the voids. The second coating film 5 is made of the same material as the first coating film 3 in Embodiment 1.

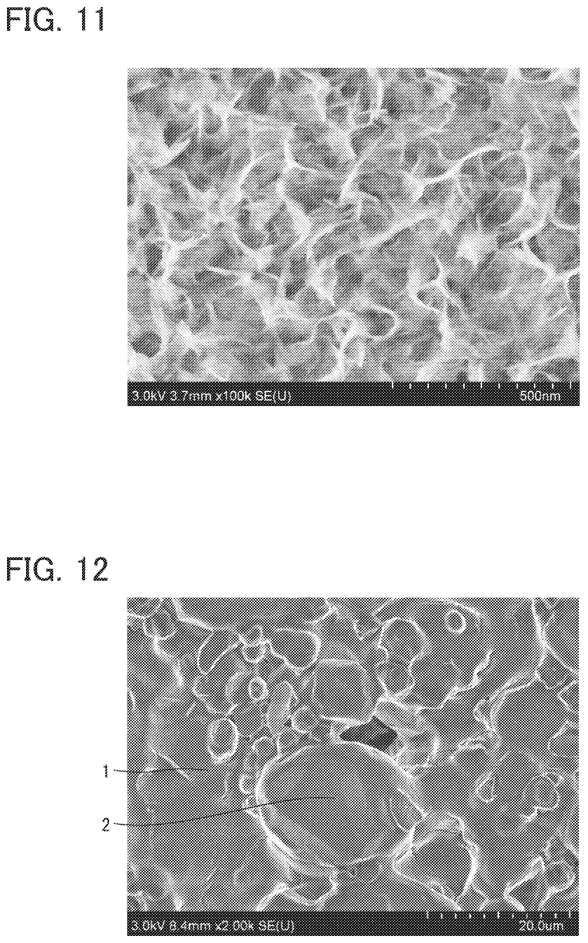

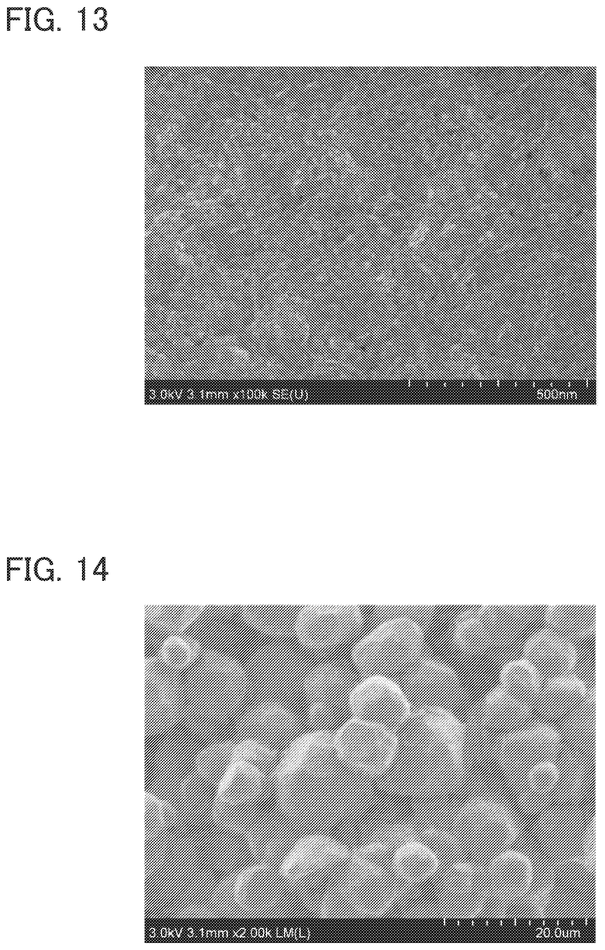

FIG. 10 is an SEM image (magnification ratio: 2,000) of the surface of the wavelength conversion element 30 in accordance with the present embodiment in which inorganic nanoparticles are used as a binder. FIG. 11 is an SEM image of the same surface, but with a magnification ratio of 100,000. FIG. 12 is an SEM image (magnification ratio: 2,000) of the surface of a wavelength conversion element of related art with no second coating film 5 thereon in which inorganic nanoparticles are used as a binder. FIG. 13 is an SEM image of the same surface, but with a magnification ratio of 100,000. The wavelength conversion element of related art with no second coating film 5 thereon in which inorganic nanoparticles are used as a binder has exposed on the surface thereof a structure in which nanoparticles of approximately a few nanometers to a few tens of nanometers aggregate.

The second coating film 5 has an irregular, fine structure thereon and particularly preferably has a flower-like structure as shown in FIGS. 10 and 11.

The provision of the second coating film 5 of a metal alkoxide with an irregular structure thereon on the wavelength conversion element 30 reduces the difference in refractive index between air and the wavelength conversion element 30, which restrains reflection at the interface between air and the wavelength conversion element 30. That in turn enhances excitation light incidence efficiency and fluorescence extraction efficiency between air and the wavelength conversion element 30, further improving luminous efficiency.

The second coating film 5 needs only to be provided on at least a part of the surface of the wavelength conversion element 30. The proportion of the area where the second coating film 5 is provided to the total surface area of the wavelength conversion element 30 is not limited in any particular manner. A larger proportion will be more effective in reducing reflection. The second coating film 5 is therefore particularly preferably provided across the entire surface, of the wavelength conversion element 30, that forms an interface between air and the wavelength conversion element 30.

### Method of Manufacturing Wavelength Conversion Element 30

The wavelength conversion element 30 in accordance with the present embodiment can be manufactured by subjecting the wavelength conversion element manufactured by the method of Embodiment 1 to the immersion step and the second firing step in the method of Embodiment 2, except that in the permeation step where the fired product is permeated with a metal alkoxide sol, the sol is applied additionally to the surface of the fired product.

The metal alkoxide sol may be applied to the surface of the fired product by a conventional technique such as spray coating, inkjet coating, dispenser coating, screen printing, or dipping. The quantity of the sol applied is not limited in any particular manner and may be specified in a suitable manner, insofar as the resulting second coating film 5 can sufficiently reduce reflection and the wavelength conversion element 30 can achieve good luminous efficiency.

### Embodiment 4

The following will describe another embodiment of the present disclosure. For convenience of description, members of the present embodiment that have the same function as members described in the previous embodiments are indicated by the same reference numerals, and description thereof is not repeated.

### Structure of Wavelength Conversion Element 40

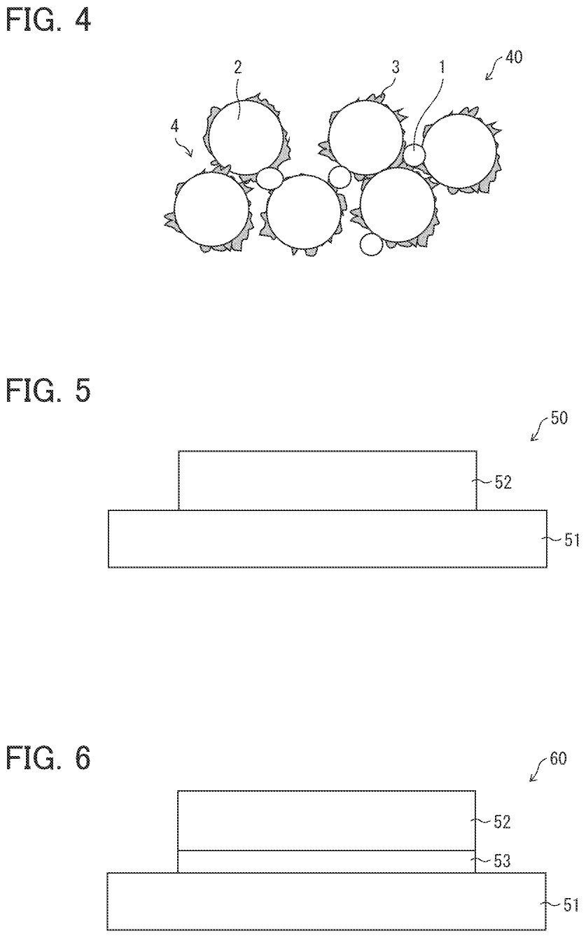

FIG. 4 is a schematic cross-sectional view of a wavelength conversion element 40 in accordance with the present embodiment. FIG. 14 is an SEM image (magnification ratio: 2,000) of the surface of the wavelength conversion element 40 in accordance with the present embodiment.

Retelling to FIGS. 4 and 14, the wavelength conversion element 40 in accordance with the present embodiment differs from Embodiments 1 to 3 in that in the former, the volume of the binder 1 accounts for so small a proportion of the total volume of the wavelength conversion element 40 that the phosphor particles 2 and the voids 4 partially adjoin and the first coating film 3 is formed on at least a part of the surface of the phosphor particles 2. The wavelength conversion element 40 has otherwise the same structure as in Embodiments 1 to 3.

In the wavelength conversion element of related art where no first coating film 3 is provided in the voids, the internal thermal conduction of the wavelength conversion element will more likely be blocked, thereby exhibiting decreased thermal conductivity, with a decrease in the relative volume of the binder and an increase in the relative volume of the voids.

Meanwhile, in the present disclosure, since the first coating film 3 on the inner wall of the voids 4 provides a thermal conduction path, the wavelength conversion element 40 has good thermal conductance and achieves high luminous efficiency even if the binder 1 has a small relative volume and the voids 4 have a large relative volume.

The proportion of the volume of the binder 1 to the total volume of the wavelength conversion element 40 is not limited in any particular manner and may be, for example, less than or equal to 30% or even less than or equal to 10%.

Similarly to the wavelength conversion element 30 in accordance with Embodiment 3, the wavelength conversion element 40 may include thereon a second coating film 5 of a metal alkoxide with an irregular structure thereon.

The binder 1 may be the same binder as in Embodiment 1 and is particularly preferably a binder containing inorganic nanoparticles of a metal oxide such as silica or alumina.

The first coating film 3 and the second coating film 5 may be made of the same metal alkoxide and/or metal oxide as in Embodiments 1 and 3.

The base material of the binder 1 may be either the same metal oxide as or a different metal oxide from the base material of the first coating film 3 and the second coating film 5.

### Embodiment 5

The following will describe another embodiment of the present disclosure. For convenience of description, members of the present embodiment that have the same function as members described in the previous embodiments are indicated by the same reference numerals, and description thereof is not repeated.

### Structure of Wavelength Conversion Device 50

FIG. 5 is a schematic cross-sectional view of a wavelength conversion device 50 in accordance with the present embodiment.

Referring to FIG. 5, the wavelength conversion device 50 in accordance with the present embodiment includes: a substrate 51; and a fluorescent layer 52 including a wavelength conversion element in accordance with any one of Embodiments 1 to 4 on the substrate 51.

The substrate 51 may be either a reflective substrate that has reflectivity to excitation light or a transmissive substrate that has transparency to excitation light.

The reflective substrate is not limited in any particular manner and is preferably, for example, a metal substrate such as an aluminum substrate, a copper substrate, or an alumina substrate for increased thermal conductivity. The substrate is more preferably coated thereon with a high reflection film of, for example, silver for improved fluorescence intensity.

The transmissive substrate is not limited in any particular manner and is preferably a glass substrate or a sapphire substrate for improved thermal conductivity.

The substrate 51 and the fluorescent layer 52 may have a thickness that is specified in a suitable manner, for example, in accordance with desired usages.

### Method of Manufacturing Wavelength Conversion Device 50

The wavelength conversion device 50 in accordance with the present embodiment can be manufactured by coating the substrate 51 with the phosphor ink composition in the film-forming step of the method of manufacturing a wavelength conversion element in accordance with Embodiments 1 to 4 and subjecting the obtained laminate to the subsequent firing and other steps.

If the wavelength conversion element 30 in accordance with Embodiment 3 is used as the fluorescent layer 52, the second coating film 5 may be provided either only on the fluorescent layer 52 including the wavelength conversion element 30 or across the entire surface of the wavelength conversion device including the substrate 51.

### Embodiment 6

The following will describe another embodiment of the present disclosure. For convenience of description, members of the present embodiment that have the same function as members described in the previous embodiments are indicated by the same reference numerals, and description thereof is not repeated.

### Structure of Wavelength Conversion Device 60

FIG. 6 is a schematic cross-sectional view of a wavelength conversion device 60 in accordance with the present embodiment.

Referring to FIG. 6, the wavelength conversion device 60 in accordance with the present embodiment differs from the wavelength conversion device 50 in accordance with Embodiment 5 in that the former includes a reflection-enhancing layer 53 between the fluorescent layer 52 and the substrate 51. The wavelength conversion device 60 has otherwise the same structure as in Embodiment 5.

The provision of the reflection-enhancing layer 53 renders the wavelength conversion device 60 less likely to be affected by the reflectance of the substrate 51 since the fluorescence from the fluorescent layer 52 is reflected off the reflection-enhancing layer 53 for output. The efficient reflection of fluorescence can further increase light use efficiency.

The reflection-enhancing layer 53 may include, for example: a multilayered oxide film such as a SiO₂/TiO₂ multilayer film; a dichroic mirror; or a scattering layer containing a binder and scattering particles.

The binder in the scattering layer may contain either an inorganic compound or an organic compound, and in view of improved thermal conductance, preferably contains an inorganic compound. This inorganic compound is, for example, alumina or silica. The organic compound is, for example, a silicone resin.

### Embodiment 7

The following will describe another embodiment of the present disclosure. For convenience of description, members of the present embodiment that have the same function as members described in the previous embodiments are indicated by the same reference numerals, and description thereof is not repeated.

### Structure of Light-Emission System

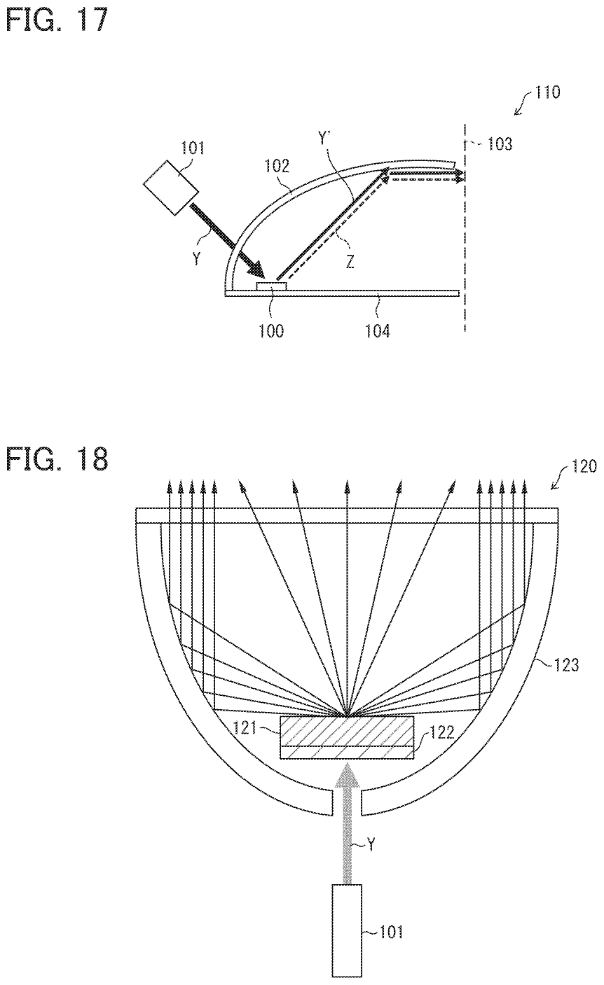

FIG. 17 is a schematic view of a light-emission system in accordance with Embodiment 7 of the present disclosure. The light-emission system is a headlight (vehicle headlight) including as a fluorescence source 100 any one of the wavelength conversion elements in accordance with Embodiments 1 to 4 and the wavelength conversion devices in accordance with Embodiments 5 and 6 and is preferably a reflective laser headlight 110.

An excitation light source 101 is preferably a blue laser source capable of emitting excitation light Y having such a wavelength as to excite phosphor particles in the fluorescence source 100. A reflector 102 is preferably built around a semi-parabolic mirror. The reflector 102 preferably has a semi-paraboloid obtained by dividing a paraboloid into two upper and lower halves along a dividing face 104 that is parallel to the x-y plane. The reflector 102 preferably has an inner surface that can serve as a mirror. The reflector 102 has a through hole through which the excitation light Y passes. The fluorescence source 100 is excited by the blue excitation light Y to emit fluorescence Z having longer, visible wavelengths (yellow wavelength). The excitation light Y also forms scattered/reflected light Y′ upon impinging on a projection surface of the fluorescence source 100. The fluorescence source 100 is located at the focal point of the paraboloid on the dividing face 104. Since the fluorescence source 100 is located at the focal point of the paraboloid mirror, the fluorescence Z and the scattered/reflected light Y′ emitted by the fluorescence source 100 reflect off the reflector 102 and travel uniformly and straightly to an exit face 103. A mixture of the fluorescence Z and the scattered/reflected light Y′, which forms white parallel light, exits through the exit face 103.

### Embodiment 8

The following will describe another embodiment of the present disclosure. For convenience of description, members of the present embodiment that have the same function as members described in the previous embodiments are indicated by the same reference numerals, and description thereof is not repeated.

### Structure of Light-Emission System

FIG. 18 is a schematic view of a light-emission system in accordance with Embodiment 8 of the present disclosure. The light-emission system is a transmissive lighting device including any one of the wavelength conversion elements in accordance with Embodiments 1 to 4 as a fluorescent layer 121 (i.e., fluorescence source) and is preferably a transmissive laser headlight 120.

FIG. 18 shows an example where the fluorescent layer 121 is disposed on a transmissive heatsink substrate 122. The fluorescent layer 121 may be provided alone with no transmissive heatsink substrate 122. If the wavelength conversion element 30 in accordance with Embodiment 3 is used as the fluorescent layer 121, the second coating film 5 may be provided either only on the fluorescent layer 121 or across the entire surface including the transmissive heatsink substrate 122. The provision of the second coating film 5 on the transmissive heatsink substrate 122 restrains reflection of incident light.

Between the transmissive heatsink substrate 122 and the fluorescent layer 121 may there be provided a dichroic mirror capable of transmitting the excitation light (wavelengths) and reflecting the fluorescence (wavelengths). The provision of a dichroic mirror between the transmissive heatsink substrate 122 and the fluorescent layer 121 prevents the fluorescence generated in the fluorescent layer 121 from exiting the fluorescent layer 121 through the side thereof facing the transmissive heatsink substrate 122, thereby increasing fluorescence extraction efficiency.

In a transmissive lighting device, the excitation light Y is projected from the side thereof opposite the fluorescence exit face so that the transmissive lighting device can fluoresce. In FIG. 18, the excitation light Y is projected from a face of the transmissive heatsink substrate 122 located opposite a face on which the fluorescent layer 121 resides. The transmissive heatsink substrate 122 is preferably capable of serving as a heatsink. It is known that if the fluorescent layer 121 is deposited on the transmissive heatsink substrate 122, and the excitation light Y enters from the heatsink side thereof, the heatsink side exhibits high heat dissipation.

The light emitted by the fluorescent layer 121 will produce fluorescence exiting through a face opposite the light-incident side. This fluorescence is reflected by a paraboloid 123 and exits the transmissive lighting device with high directionality.

### Embodiment 9

The following will describe another embodiment of the present disclosure. For convenience of description, members of the present embodiment that have the same function as members described in the previous embodiments are indicated by the same reference numerals, and description thereof is not repeated.

### Structure of Light-Emission System

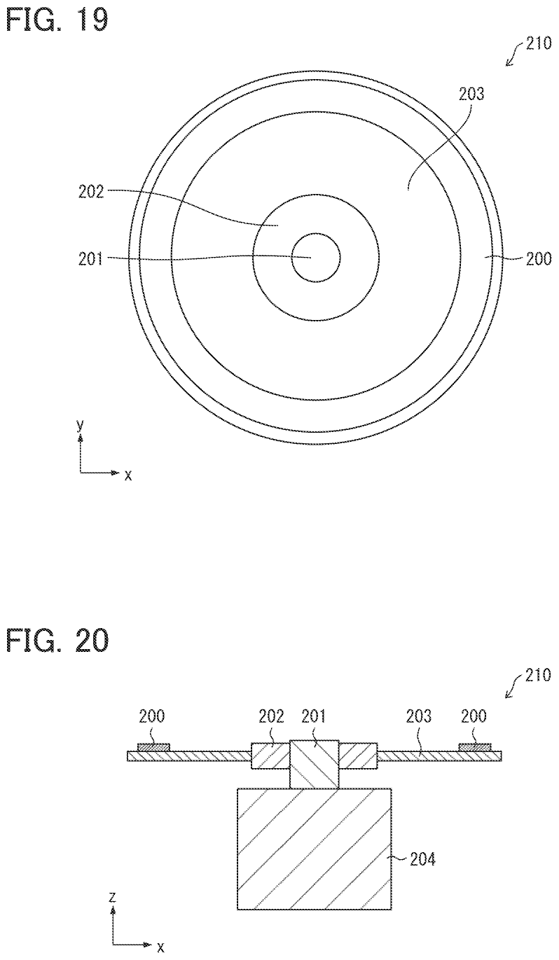

FIG. 19 is a schematic plan view (x-y plane) of a light-emission system in accordance with Embodiment 9 of the present disclosure. The light-emission system is a fluorescent wheel 210 including as a fluorescent layer 200 (i.e., fluorescence source) any one of wavelength conversion elements in accordance with Embodiments 1 to 4 and the wavelength conversion devices in accordance with Embodiments 5 and 6. The fluorescent wheel 210 includes the fluorescent layer 200 which in turn includes at least any one of the wavelength conversion elements 10, 20, 30, and 40 and the wavelength conversion devices 50 and 60 and which is provided on at least a part of the periphery of the surface of a wheel 203 that receives the excitation light emitted by the light source.

The fluorescent wheel 210 needs only to include the fluorescent layer 200 which in turn includes at least any one of the wavelength conversion elements 10, 20, 30, and 40 and the wavelength conversion devices 50 and 60 and which is provided on at least a part of the periphery of the surface of the wheel 203 that receives the excitation light emitted by the light source. The fluorescent layer 200 is preferably disposed on the wheel 203 like concentric circles.

The fluorescent layer 200 is deposited on at least a part of the periphery of the surface of the wheel 203 in a preferred embodiment.

FIG. 20 is a schematic side view (x-z plane) of a light-emission system including as well as the fluorescent wheel 210 a driving device 204 for rotating the wheel 203.

In the light-emission system, the wheel 203 is fixed by a wheel fixing member 202 to a rotation shaft 201 of the driving device 204. The driving device 204 is preferably an electric motor, so that the wheel 203 fixed by the wheel fixing member 202 to the rotation shaft 201, which is a rotation shaft of the electric motor, can rotate with rotation of the electric motor.

The fluorescent layer 200, deposited on at least a part of the periphery of the surface of the wheel 203, emits fluorescence under excitation light. Since the fluorescent layer 200 rotates with rotation of the wheel 203, the fluorescent layer 200 emits fluorescence while rotating.

### Embodiment 10

The following will describe another embodiment of the present disclosure. For convenience of description, members of the present embodiment that have the same function as members described in the previous embodiments are indicated by the same reference numerals, and description thereof is not repeated.

### Structure of Light-Emission System

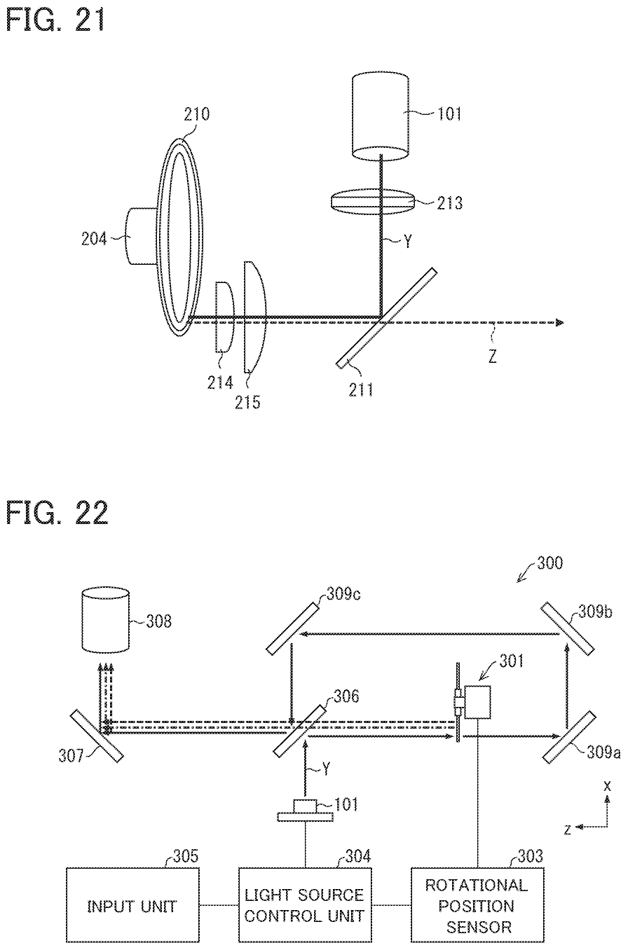

FIG. 21 is a schematic view of a light-emission system in accordance with Embodiment 10 of the present disclosure. The light-emission system includes as well as the fluorescent wheel 210 described in Embodiment 9: a driving device 204 for rotating the wheel 203; and an excitation light source 101. The light-emission system is preferably used in, for example, a projector.

The excitation light source 101 is preferably a blue laser source capable of emitting the excitation light Y having such a wavelength as to excite the fluorescent layer 200. The excitation light source 101 is a blue laser diode capable of exciting a phosphor such as YAG or LuAG in a preferred embodiment. The excitation light Y projected onto the fluorescent layer 200 passes through lenses 213, 214, and 215 on the optical path thereof. There may be provided a mirror 211 on the optical path of the excitation light Y. The mirror 211 is preferably a dichroic mirror.

The fluorescent layer 200, deposited on at least a part of the periphery of the surface of the wheel 203, emits the fluorescence Z under the excitation light Y. The fluorescence Z passes through the mirror 211 and exits.

### Embodiment 11

The following will describe another embodiment of the present disclosure. For convenience of description, members of the present embodiment that have the same function as members described in the previous embodiments are indicated by the same reference numerals, and description thereof is not repeated.

### Stricture of Light-Emission System

FIG. 22 is a schematic view of a light-emission system in accordance with Embodiment 11 of the present disclosure. The light-emission system is a projection device 300 including the light-emission system described in Embodiment 10 as a light source device 301.

The projection device 300 includes: a light source device 301; a rotational position sensor 303 for acquiring the rotational position of the fluorescent wheel 210; a light source control unit 304 for controlling the excitation light source 101 on the basis of the output information of the rotational position sensor 303; a display element 307; a light-source optical system 306 for guiding light from the light source device 301 to the display element 307; and an image-projection optical system 308 for projecting projection light from the display element 307 onto a screen.

The projection device 300 controls the output of the excitation light source 101 on the basis of the information on the rotational position of the fluorescent wheel 210 that is acquired by the rotational position sensor 303. The light source device 301 includes the fluorescent wheel 210 on at least a part of the periphery through which the excitation light Y emitted by the excitation light source 101 passes. The fluorescent wheel 210 includes a wavelength conversion element along the periphery thereof.

If the fluorescent wheel 210 has a transmitting portion in a part thereof, the excitation light Y which is blue, travels through the fluorescent wheel 210 via the transmitting portion. The excitation light Y projected onto the fluorescent layer 200 can pass through the light-source optical system 306 and mirrors 309a to 309c on the optical path thereof. The light-source optical system 306 is preferably a dichroic mirror. A preferable dichroic mirror is capable of reflecting blue light incident at 45° and transmitting red and green light incident at 45°.

To discuss in more detail, the light-source optical system 306, including a dichroic mirror with the optical properties described above, allows the excitation light Y, which is blue, incident to the dichroic mirror to be reflected toward the fluorescent wheel 210. Depending on the timing of the rotation of the fluorescent wheel 210, the blue light can transmit the fluorescent wheel 210 via the transmitting portion. The excitation light Y projected onto the non-transmitting portions, depending on the timing of the rotation of the fluorescent wheel 210, can impinge on the fluorescent layer 200 so that the fluorescent layer 200 can fluoresce. The red and green light in the fluorescence transmits through the dichroic mirror through and enters the display element 307. The blue light, after transmitting through the transmitting portion, travels through the mirrors 309a to 309c and again impinges on the dichroic mirror, hence reflecting again off the dichroic mirror and entering the display element 307.

The projector (projection device 300) may include the light source device 301, the display element 307, the light-source optical system 306 (dichroic mirror), and the image-projection optical system 308 in a preferred embodiment. The light-source optical system 306 (dichroic mirror) guides light from the light source device 301 to the display element 307, so that the image-projection optical system 308 can project projection light from the display element 307 onto, for example, a screen. The display element 307 is preferably a DMD (digital mirror device) in a preferred embodiment. The image-projection optical system 308 is preferably a combination of projection unit lenses.

### Embodiment 12

The following will describe another embodiment of the present disclosure. For convenience of description, members of the present embodiment that have the same function as members described in the previous embodiments are indicated by the same reference numerals, and description thereof is not repeated.

### Structure of Light-Emission System

A light-emission system in accordance with the present embodiment includes: a substrate; a light-emitting element chip and a metal or non-metal conductor (electrodes), all on the substrate; and a sealing section for sealing the light-emitting element chip. The sealing section is a light-emitting device including, for example, any one of the wavelength conversion elements in accordance with Embodiments 1 to 4. The light-emitting element chip and the conductor are electrically connected on the substrate. The substrate may either resemble a housing or have another shape. The light-emitting element chip is an LED light-emitting diode) chip in a preferred embodiment.

In a preferred embodiment, part of the light emitted by the LED chip is converted in wavelength by the sealing section including any one of the wavelength conversion elements in accordance with Embodiments 1 to 4. White light is obtained by the extraction of the mixture of that part of the light emitted by the LED chip which is not converted in wavelength by the sealing section and that part of the light emitted by the LED chip which is converted in wavelength by the sealing section.

If the wavelength conversion element 30 in accordance with Embodiment 3 is used as the sealing section, the second coating film 5 may be provided either only on the sealing section or across the entire surface including the substrate. For instance, at least a part of the surface of the substrate may be coated with the second coating film 5 of a metal alkoxide with an irregular structure thereon.

### General Description

The present disclosure, in aspect 1 thereof, is directed to a wavelength conversion element (10, 20, 30, 40) including: a binder (1); a plurality of phosphor particles (2) dispersed in the binder (1), the plurality of phosphor particles (2) being configured to emit light with a prescribed wavelength under excitation light (Y); and a plurality of voids dispersed in the binder (1), at least some of the plurality of voids including, on at least a part of an inner wall thereof, a first coating film (3) formed from metal alkoxide.

In aspect 2 of the present disclosure, the wavelength conversion element (20, 30, 40) of aspect 1 may be configured such that the first coating film (3) has an irregular structure thereon.

In aspect 3 of the present disclosure, the wavelength conversion element (20, 30, 40) of aspect 2 may be configured such that the irregular structure is a flower-like structure.

In aspect 4 of the present disclosure, the wavelength conversion element (30, 40) of any one of aspects 1 to 3 may be configured such that the wavelength conversion element (30, 40) has a surface at least a part of which is coated with a second coating film (5) formed from metal alkoxide, the second coating film having an irregular structure thereon.

The present disclosure, in aspect 5 thereof, is directed to a wavelength conversion device (50, 60) including: a fluorescent layer (52) including the wavelength conversion element (10, 20, 30, 40) of any one of aspects 1 to 4; and a substrate (51).

In aspect 6 of the present disclosure, the wavelength conversion device (50, 60) of aspect 5 may be configured such that the substrate (51) is a reflective substrate that has reflectivity to the excitation light (Y).

In aspect 7 of the present disclosure, the wavelength conversion device (60) of aspect 6 may be configured so as to further include a reflection-enhancing layer (53) between the fluorescent layer (52) and the reflective substrate.

In aspect 8 of the present disclosure, the wavelength conversion device (50, 60) of aspect 5 may be configured such that the substrate (51) is a transmissive substrate that has transparency to the excitation light (Y).

In aspect 9 of the present disclosure, the wavelength conversion device (50, 60) of aspect 8 may be configured such that the transmissive substrate has a surface at least a part of which is coated with a second coating film formed from metal alkoxide, the second coating film having an irregular structure thereon.

The present disclosure, in aspect 10 thereof, is directed to a light-emission system including a fluorescence source that is either the wavelength conversion element (10, 20, 30, 40) of any one of aspects 1 to 4 or the wavelength conversion device (50, 60) of any one of aspects 5 to 9.

In aspect 11 of the present disclosure, the light-emission system of aspect 10 is configured such that the light-emission system is a vehicle headlight and further includes: an excitation light source (101) configured to project excitation light onto the fluorescence source (100); and a reflector (102) having a reflection surface that reflects fluorescence emitted by the fluorescence source (100), wherein the reflection surface of the reflector (102) has such a shape as to reflect incident light in a single direction as parallel light.

In aspect 12 of the present disclosure, the light-emission system of aspect 10 is configured such that the light-emission system is a transmissive lighting device, wherein the fluorescence source (121) is either the wavelength conversion element (10, 20, 30, 40) of any one of aspects 1 to 4 or the wavelength conversion device (50, 60) of any one of aspects 5 and 8 to 9, and the fluorescence source (121) has an irradiated surface to which excitation light is projected and a surface opposite the irradiated surface, the light-emission system further including an excitation light source (101) on a same side as the irradiated surface with respect to the fluorescence source (121).

In aspect 13 of the present disclosure, the light-emission system of aspect 10 is configured such that the light-emission system is a fluorescent wheel (210) and further includes a wheel (203), wherein the fluorescence source (200) is provided on at least a part of a periphery of a surface of the wheel (203).

In aspect 14 of the present disclosure, the light-emission system of aspect 10 is configured such that the light-emission system is a light source device and further includes: a wheel (203); a driving device (204) configured to rotate the wheel (203); and an excitation light source (101) configured to project excitation light onto the fluorescence source (200), wherein the fluorescence source (200) is provided on at least a part of a periphery of a surface of the wheel (203), and the fluorescence source (200) emits fluorescence when the fluorescence source (200) is under excitation light as a result of rotation of the wheel (203).

In aspect 15 of the present disclosure, the light-emission system of aspect 10 is configured such that the light-emission system is a projection device (300) and further includes: a display element (307); a light-source optical system (306) configured to guide fluorescence from the fluorescence source (200) to the display element (307); and an image-projection optical system (308) configured to project projection light from the display element (307) onto a screen.

in aspect 16 of the present disclosure, the light-emission system of aspect 10 is configured such that the light-emission system is a light-emitting device and further includes: a substrate; and alight-emitting element chip and a conductor, both on the substrate, wherein the fluorescence source is the wavelength conversion element (10, 20, 30, 40) of any one of aspects 1 to 4 and provides a sealing section sealing the light-emitting element chip.

The present disclosure is not limited to the description of the embodiments above and may be altered within the scope of the claims. Embodiments based on a proper combination of technical means disclosed in different embodiments are encompassed in the technical scope of the present disclosure. Furthermore, new technological features can be created by combining different technical means disclosed in the embodiments.

1. A wavelength conversion element comprising:
a binder;
a plurality of phosphor particles dispersed in the binder, the plurality of phosphor particles being configured to emit light with a prescribed wavelength under excitation light; and
a plurality of voids dispersed in the binder, wherein
at least some of the plurality of voids includes, on at least a part of an inner wall thereof, a first coating film formed from metal alkoxide, and
a surface of the first coating film dispersed in the binder has a flower-like structure.

2. (canceled)

3. (canceled)

4. The wavelength conversion element according to claim 1, wherein the wavelength conversion element has a surface at least a part of which is coated with a second coating film formed from metal alkoxide, the second coating film having an irregular structure thereon.

5. A wavelength conversion device comprising:
a fluorescent layer including the wavelength conversion element according to claim 1; and
a substrate.

6. The wavelength conversion device according to claim 5, wherein the substrate is a reflective substrate that has reflectivity to the excitation light.

7. The wavelength conversion device according to claim 6, further comprising a reflection-enhancing layer between the fluorescent layer and the reflective substrate.

8. The wavelength conversion device according to claim 5, wherein the substrate is a transmissive substrate that has transparency to the excitation light.

9. The wavelength conversion device according to claim 8, wherein the transmissive substrate has a surface at least a part of which is coated with a second metal alkoxide coating that has an irregular structure thereon.

10. A light-emission system comprising a fluorescence source that is either the wavelength conversion element according to claim 1.

11. The light-emission system according to claim 10, the light-emission system being a vehicle headlight and further comprising:
an excitation light source configured to project excitation light onto the fluorescence source; and
a reflector having a reflection surface that reflects fluorescence emitted by the fluorescence source, wherein
the reflection surface of the reflector has such a shape as to reflect incident light in a single direction as parallel light.

12. The light-emission system according to claim 10, the light-emission system being a transmissive lighting device, wherein
the fluorescence source is either the wavelength conversion element according to f claim 1, and
the fluorescence source has an irradiated surface to which excitation light is projected and a surface opposite the irradiated surface,
the light-emission system further comprising an excitation light source on a same side of the fluorescence source as the irradiated surface.

13. The light-emission system according to claim 10, the light-emission system being a fluorescent wheel and further comprising a wheel, wherein
the fluorescence source is provided on at least a part of a periphery of a surface of the wheel.

14. The light-emission system according to claim 10, the light-emission system being a light source device and further comprising:
a wheel;
a driving device configured to rotate the wheel; and
an excitation light source configured to project excitation light onto the fluorescence source, wherein
the fluorescence source is provided on at least a part of a periphery of a surface of the wheel, and
the fluorescence source emits fluorescence when the fluorescence source is under excitation light as a result of rotation of the wheel.

15. The light-emission system according to claim 10, the light-emission system being a projection device and further comprising:
a display element;
a light-source optical system configured to guide fluorescence from the fluorescence source to the display element; and
an image-projection optical system configured to project projection light from the display element onto a screen.

16. The light-emission system according to claim 10, the light-emission system being a light-emitting device and further comprising:
a substrate; and
a light-emitting element chip and a conductor, both on the substrate, wherein
the fluorescence source is the wavelength conversion element according to claim 10 and provides a sealing section sealing the light-emitting element chip.
